(19) United States
(12) Patent Application Publication
(10) Pub. No.: US 2008/0148920 A1
(43) Pub. Date: Jun. 26, 2008

(54) Stringed-instrument chord player with built-in plectrum (Pick) holder

(76) Inventor: Emily Serena Graves, Oro Valley, AZ (US)

Correspondence Address: Emily S. Graves, 10129 N. Valle Del Oro, Oro Valley, AZ, 85737, US

(21) Appl. No.: 11/642,902

(22) Filed: Dec. 20, 2006

(51) Int. Cl. G10D 3/16

(52) U.S. Cl. 84/320

(57) ABSTRACT

The invention described serves the stringed musical instrument player as a chord player (multiple notes at one time) and a rigid holding device for the guitar pick, for playing single notes at a time, with greater control, tone, and power

### FEDERALLY SPONSORED RESEARCH

Not applicable

### SEQUENCE LISTING OR PROGRAM

Not applicable

### BACKGROUND OF THE INVENTION

1. Field of Invention

This invention relates to playing stringed musical instruments, specifically to a new device used to play stringed musical instruments, such as a guitar, or others.

2. Prior Art

There does exist, as prior art, a part of this invention, namely, the guitar pick, which is incorporated into the present invention. It is the part held by the mounting fixture on this invention's device body, which is a wooden dowel, shown in the prototype. One problem with the guitar pick is that of the slippage of the guitar pick from its position in the hand of the player, or even dropping the pick while playing. Picks are thin and are known to become wet and slippery and can easily be dropped as a result. Players frequently need to have many picks on reserve when playing live performances because of this slippage problem. Players typically have many spare picks mounted on their guitar bodies to address this need. In fact there are special containers, commercialized products, which hold extra picks that are mounted on guitar bodies, for this purpose.

There does not appear to be any similar devices offered on the musical instrument marketplace, as determined by a survey of the Internet and the current musical periodicals, such as Guitar Player, Guitar One, and other similar ones for sale in bookstores. To clarify, there does not appear to be any other devices (for playing a musical stringed instrument) that either separately or by combination provide the capabilities of this invention.

Two existing pieces of prior art are the guitar pick and the wooden dowel, being incorporated as parts of this invention. Similarly, other parts are the leather patch, glue, and the three small nails that are used to attach the patch onto the wooden body.

The next three items can best be described as material parts that exist as basic building blocks of the invention, not being entire products in themselves, but rather materials.

Another instance of a part of the invention that exits is the wooden dowel. Instances of wooden dowels can be purchased at shops that sell wood supplies, such as Home Depot, hobby shops, hardware shops, and the like. The invention could also be implemented with similarly shaped objects made of different material, such as plastic, metal, or perhaps a ceramic composite. In any case, a wooden dowel serves well as a base upon which to build the invention's capabilities.

Another instance of a part of the invention that exits is the piece of rubber that forms the part of the invention that is used to strike the strings, but is covered by the piece of leather wrapped around the rubber, described next.

A larger block of rubber can be purchased and, in the construction process, an appropriately sized small section of the larger block can be cut off for producing the invention's part.

Another instance of a part of the invention that exits is the piece of leather that forms the part of the invention that is used to strike the strings. The piece of leather is wrapped around the rubber and is used to fix the rubber block on the dowel.

### BACKGROUND OF THE INVENTION—OBJECTS AND ADVANTAGES

Accordingly, several objects and advantages of the present invention are:

(a) To provide the capability of supporting stringed instruments players' wish to play more than one, or even all, strings of a stringed musical instrument, such as a guitar, simultaneously. This capability is implemented by the padded striking surface of the rubber pad wrapped in leather that is mounted onto the wooden dowel, which is used to strike the strings of the stringed musical instrument.
(b) The capability to simultaneously strike all the strings of the stringed musical instrument supports a player's ability to create a new powerful tone, which differs from striking the strings one at a time, in sequence, which is the current nominal method rendered by using an ordinary guitar pick. This is called an arpeggio.
(c) The capability to simultaneously strike all the strings of the stringed musical instrument supports a player's ability to create new rhythmic patterns that are not available by using the current guitar pick which limits the player to playing one note at a time, in sequence, even if it is a rapid strumming motion.

To enjoy a more secure gripping device that holds a guitar plectrum (pick) more firmly, by having a mounting fixture in the dowel for the pick to be held, thus, the player can hold the playing device, with it's mounted pick, in a more secured grip, resembling how one holds a pencil, which can be used to play single notes or chords. The mounting fixture on the dowel, whereby the pick is attached securely to the dowel, implements this capability. This is essentially a notched groove slit that is cut into the end of the dowel wherein the pick is glued. The end of the dowel should also be rounded slightly for a better, smoother, grip area.

(d) The firmer grip supports a player's ability to more easily produce a stronger, more intense tone on the strings of the guitar, as provided by the greater leverage and torque force provided by the current invention's structure.
(e) The firmer grip supports a player's ability to produce a tone on the strings of the guitar at greater rate of speed, provided the player's ability to utilize this capability is sufficiently developed.

### SUMMARY

In accordance with the present invention, a stringed musical instrument, such as a guitar, can be better played with the present invention by virtue of its capabilities, such as the chord striking surface and the mounted pick. In the present invention, as a current prototype, a dowel of approximately 8 to 10 inches, in length, serves as a base upon which to affix the chord-striking surface, consisting of a rubber strip covered in leather, mounted on the dowel with glue and small nails, and a pick mounted onto the opposite end in a groove in which the pick is fixed with glue.

### DRAWINGS—FIGURES

FIG. 1. Stringed-Instrument Chord Player with built-in Plectrum (Pick) Holder shows the main parts of the invention, which are labeled with sub-parts (1-A) to (1-D).

FIG. 1 Sub-part (1-A) Pick

This part shows a typical guitar pick mounted in the groove cut into the dowel body, which goes along the length of the dowel body.

FIG. 1 Sub-part (1-B) Dowel, wooden base

This part shows the base part of the invention, the dowel body upon which the other parts are mounted.

FIG. 1 Sub-part (1-C) Striking pad, rubber block.

This part shows a rubber block that serves as the basis for the chord striker. It is wrapped by the leather patch piece, shown in FIG. 1 Sub-part (1-D).

FIG. 1 Sub-part (1-D) Wrapping material, leather patch.

This part shows a piece of wrapping material, made with a leather patch, that encircles the rubber block, shown in sub-part (1-C).

FIG. 2 Sub-part (2-A) shows the groove cut into dowel body, in the end on view, in which the black line represents where a slot has been cut into the dowel body.

FIG. 2 Sub-part (2-B) shows the dowel body, in the end on view, in which the dowel body is represented as an oval, as an artifact of the drawing tool, since it is supposed to be a circle.

FIG. 3 Sub-part (3-A) shows the chord striker rubber pad, in the end-on view of the chord striker rubber pad, which is a rectangular block, in the end on view, in which the black line represents where a slot has been cut into the dowel body.

FIG. 3 Sub-part (3-B) shows the dowel body, in the end on view, in which the dowel body is represented as an oval, as an artifact of the drawing tool, since it is supposed to be a circle.

FIG. 4 Sub-part (4-A) shows the leather patch wrapping material (also 1-D), keeping chord striker rubber pad, stabilized in a fixed position on the dowel.

FIG. 4 Sub-part (4-B) shows the Chord striker rubber pad in the end on view.

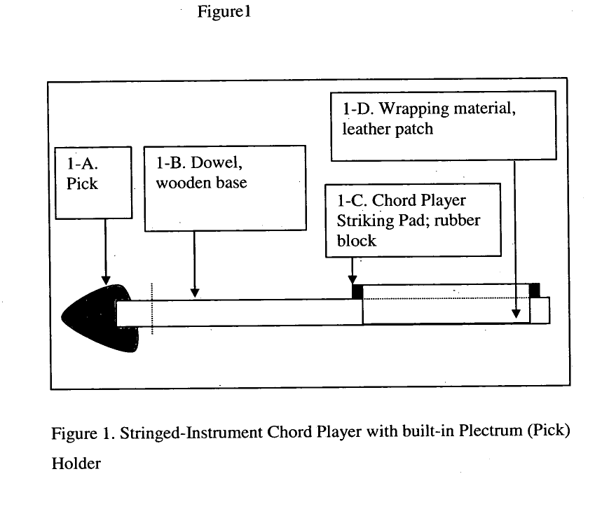

### DRAWINGS—REFERENCE NUMERALS

1-A. Pick
1-B. Dowel, wooden base
1-C. Chord Player Striking Pad; rubber block
1-D. Wrapping material, leather patch
1-E. Groove cut into dowel body
2-A. Groove cut into dowel body (end on view)
2-B. Dowel body, (end on view)
3-A. Chord striker rubber pad, end on view of rectangular block
3-B. Dowel body, end on view
4-A Leather patch wrapping material
4-B. Chord striker rubber pad

### DETAILED DESCRIPTION—FIG.—PREFERRED EMBODIMENT

A preferred embodiment of the present invention is illustrated in figures: 1-A, 1-B, 1-C, 1-D, 2-A, 2-B, 3-A, 3-B, 4-A, 4-B.

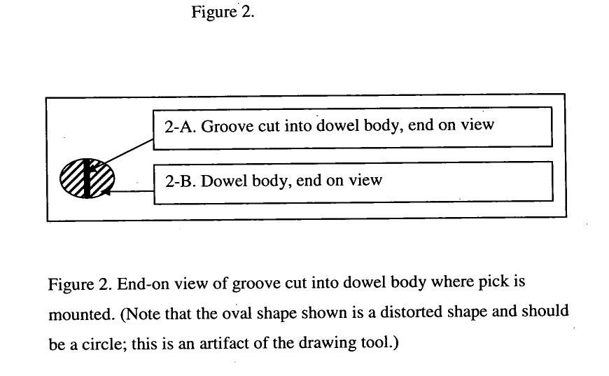

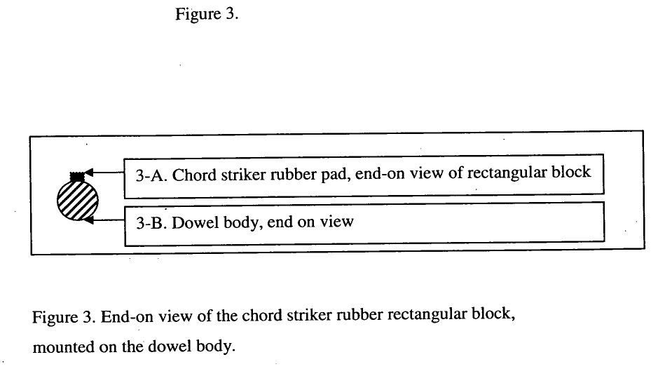

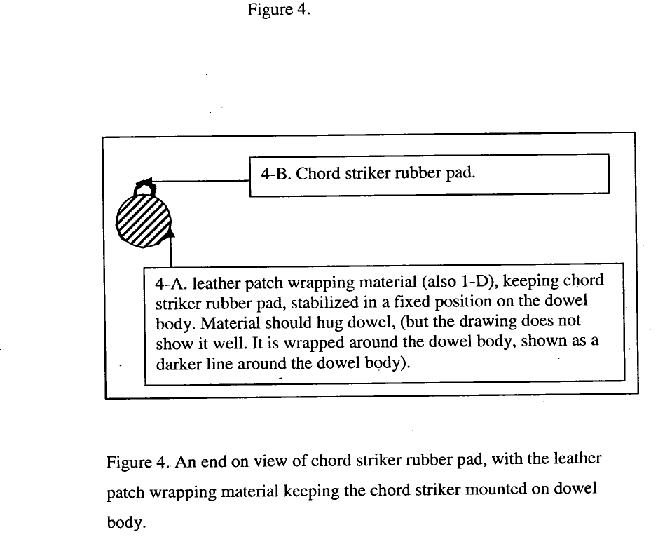

The wooden dowel (1-B) serves as the base unit that has the functional items mounted on it. These items mounted are the guitar pick (1-A) that the player uses to strike individual strings, the chord player striking pad (1-C) the player uses to strike chords (multiple strings at the same time), the wrapping material (leather patch) (1-D) that fastens the chord player striking pad onto the dowel body. The remaining FIGS. 2-A, 2-B, 3-A, 3-B, 4-A, 4-B, show these parts from the end-on view, for clarification of the design.

### ALTERNATE EMBODIMENT

none

### Advantages:

(a) Enabling the player to grip the pick with less probability of dropping it, since it is held in a tightly bound grip on the dowel body, which the players' hand can grip more securely, similar to that of a pencil grip.
(b) Providing the player with a playing device that more easily supports playing with greater tone, power, and control, by having the pick mounted on the dowel body.
(c) Supporting the player's wish to play chords with simultaneously played notes, which differs from the tone generated by playing the strummed chords that consist of a series of single notes sounded separately in a sequence, called an arpeggio. Repeated chord striking provides the player with new rhythmic possibilities and an opportunity to produce innovative songs.

I claim:

1. Chord Player Striking Pad: the Chord Player Striking Pad, which consists of a rubber block, glued onto the dowel body (of approximately 8 to 10 inches in length and approx ½ inch diameter), and fastened onto the dowel thereof, by the leather wrapping material, that encircles said rubber block, and is nailed onto the said wooden dowel.

2. Striking Pad Cover: the Striking Pad Cover (leather or plastic, or some other material) wrapping material that encircles said Chord Player Striking Pad (nominally a rubber block) and serves to fasten said block to said dowel, by using a set of small nails driven into the block and glue, to fasten the said pad material onto the block, serving to fasten the block onto the dowel body.

3. Pick Groove Slice: the Pick Groove Slice cut into the dowel body serves as the mounting point of the guitar pick mounted onto said dowel body. This slice will need to be cut into the dowel body by a small saw in the manufacturing process. It provides the area where the guitar pick is inserted and glued into the dowel body cavity formed in said dowel body. This marks the end of the (three independent) claims section, thank-you for your attention.
